(19) United States
(12) Patent Application Publication
(10) Pub. No.: US 2016/0078492 A1
(43) Pub. Date: Mar. 17, 2016

(54) METHOD AND DEVICE FOR ADAPTING AN ADVERTISING MEDIUM TO AN AREA SURROUNDING AN ADVERTISING MEDIUM

(71) Applicant: Manfred RIETZLER, Marktoberdorf (DE)

(72) Inventor: Manfred Rietzler, Marktoberdorf (DE)

(21) Appl. No.: 14/890,075

(22) PCT Filed: Feb. 14, 2015
(86) PCT No.: PCT/IB2015/000153

§ 371 Date: Nov. 9, 2015

(30) Foreign Application Priority Data
Feb. 28, 2014 (DE) 10 2014 002 675.2

(51) Int. Cl. G06Q 30/02; G06K 9/78; G06K 9/80; G06T 7/20; G06K 9/20; G06K 9/46; G06K 9/00; G06T 7/00

(52) U.S. Cl. CPC G06Q 30/0269; G06K 9/00369; G06K 9/78; G06T 7/0044; G06T 7/204; G06K 9/2054; G06K 9/46; G06K 9/80

(57) ABSTRACT

The invention pertains to a method and a device for adaptation of the advertising content of an advertising medium to an advertising medium environment,
which advertising medium being formed as a display means (11), wherein an image capture means (12) registers a target person or a target group present in line of sight with the display means,
an image processing means (13) analyses the registered image information as to at least one real parameter (r1, r2, r3) characterizing the target person or the target group or the advertising medium environment, a parameter allocation means (14) allocates an image parameter (b1, b2, b3) to the real parameter, which image parameter defines an image or an image sequence,
an image generation means (15) generates an image or an image sequence depending on the image parameter, and
a display control means (16) displays the image or the image sequence on the display as advertising content.

The invention pertains to a method and a device for adaptation of the advertising content of an advertising medium to an advertising medium environment, which advertising medium being formed as a display means, wherein an image capture means registers a target person or a target group present in the advertising medium environment and in line of sight with the display means, an image processing means analyses the registered image information as to at least one real parameter characterizing the target person or the target group or the advertising medium to environment, a parameter allocation means allocates at least one image parameter to the real parameter, which image parameter defines an image or an image sequence, an image generation means generates an image or an image sequence depending on the image parameter, and a display control means displays the image or the image sequence on the display as advertising content. Beyond that the invention pertains to an advertising medium system for performing the method.

Advertising media are used for animating consumers for purchasing products. Generally display means show the products within a product environment, which are supposed to be attractive for the consumer and are to suggest to the consumer, that he will be able to get access to the desired product environment just by purchasing the respective product.

Therefore it is common knowledge that it is substantial, to present the product in a way which is specific for the particular consumer in order to be successful in marketing the product, thus presenting the product in a product environment which attracts the target person. Hence there are different advertising contents or advertising messages set for one and the same product depending on the particular target person and which are activated as the case may be. Thus it is necessary to take account to the advertising medium environment when activating the particular appropriate advertising content, in order to decide on the suitable advertising content upon analyzing the advertising medium environment by experts. That turns out to be extremely time-consuming in practice.

Thus it is an object of the invention to provide for a method and a device for performing the method which enable an advertising of products specific for the particular consumer without the need for an analysis of experts.

In order to solve that object the inventive method comprises the features of claim 1.

According to the invention there is a method for adaptation of the advertising content of an advertising medium to an advertising medium environment, which advertising medium being formed as a display means, wherein an image capture means registers a target person or a target group present in the advertising medium environment and in line of sight with the display means an an image processing means analyses the registered image information as to at least one real parameter characterizing the target person or the target group or the advertising medium environment, so that an advertising content specific for the particular consumer is activated by the target person and a feature characterizing the target person respectively.

According to the invention a parameter allocation means allocates at least one image parameter to the real parameter, which image parameter defines an image or an image sequence. That image parameter or that image sequence is provided by an image generation means in such a way that for example the image generation means elects depending on the image parameter an image or an image sequence from a library of images and image sequences, and then the image or the image sequence is displayed on the display means as advertising content.

Thus as a result the advertising content is defined in-situ by the target person registered in the advertising medium environment without need for a time-consuming analysis of the advertising medium environment and without need for a decision of an expert as to the appropriate advertising content.

If at least one feature characterizing the outer appearance of the target person is registered as said real parameter, it is possible to elect just one real parameter from the variety of real parameters of the advertising medium environment which real parameter characterizes the advertising medium environment by individualization of just one target person.

It is possible to analyze the advertisement medium environment in a more detailed way by registering as said real parameter the relative position or the relative movement of the target person or the target group relative to another person or an object within the advertising medium environment. Thus it is possible to consider the social behavior or the social position of the target person.

The object of the invention is also solved by an advertising medium system having the features of claim 5.

According to the invention the advertising medium comprises a display means as advertising medium for presentation of an advertising content using an image or an image sequence and further comprises an image capture means for registering a target person or a target group present in an advertising medium environment and in line of sight with said display means and an image processing means for analyzing the registered image information as to at least one real parameter characterizing the target person or the target group or the advertising medium environment, so that the advertising content specific to the particular consumer is activated by the target person and a feature characterizing the target person respectively.

According to the invention a parameter allocation means is provided for allocating at least one image parameter to the real parameter, which image parameter defines an image or an image sequence and an image generation means is provided for generating an image or an image sequence depending on the image parameter in such a way that for example the image generation means elects depending on the image parameter an image or an image sequence from a library of images and image sequences and a display control means is provided for displaying the image or the image sequence on the display means as advertising content.

Thus as a result the advertising content is defined in-situ by the target person registered in the advertising medium environment without need for a time-consuming analysis of the advertising medium environment and without need for a decision of an expert as to the appropriate advertising content.

A particular simple embodiment of the advertising medium system is achieved when the image processing means is designed to register at least one feature characterizing the outer appearance of the target person or the target group as said real parameter.

An advertising medium system which is even more considering the advertising medium environment will be possible when the image processing means is designed to register the relative position or the relative movement of the target person or the target group relative to another person or an object within the advertising medium environment as said real parameter. Thus it is possible to consider the social behavior or the social position of the target person.

It is possible to provide for a particular fast adaption of the advertising content when the image generation means comprises an image memory storing images or image sequences and comprises a processor unit for assigning said image parameter to an image or an image sequence and for transferring said image or said image sequence to the display control means.

Alternatively there is the option not to access dependent on the image parameter directly to images or image sequences stored in the image memory but to generate at first an action plot dependent on the image parameter or several image parameters, which action plot defines the chronological order of the images or the image sequences in the advertising content.

If according to a further favorable embodiment of the advertising medium system the image capture means comprises at least one first and on second image capture unit, said first capture unit being designed to register the target person or the target group and said second image capture unit being designed to register the advertising medium environment, not only the target person but also the further advertising medium environment can be determinant for the advertising content.

Particularly in case of an advertising medium system not being active continuously it is favorably, when the advertising medium system is provided with at least one sensor device for triggering the advertising medium system.

Beyond that the advertising medium system can be provided with at least one sensor device for registering at least one further real parameter, so that for example the climate or the recent time of day in the advertising medium environment can be considered.

A particular favorable use of the advertising medium system is enabled, if according to another solution of the invention according to claim 13 there is provided for a vending machine, which vending machine comprises a product storing means for storing the products offered for sale wherein said product storing means being provided with an advertising medium system according to the invention.

If the advertising medium system covers optically at least partly the products stored in the product storing means with an advertising content presented with the advertising medium system, the target person is able to realize the advertised real product simultaneously with the advertising content, wherein a particular close relation of the real product with the advertising content is achieved, when for optically covering the products the advertising medium system comprises a display means being at least partly transparent.

If at least the image capture means being an integral part of the vending machine, the effort as to the installation of preparing the vending machine provided with the advertising medium system is reduced.

In order to provide for a particular tightly arranged vending machine it is favorable that the advertising medium system in total being an integral part of the vending machine.

For rendering a prompt statistical evaluation of parameters being specific for the location of the vending machine and influencing the consumer behavior which evaluation is based on comparison of several it is favorable, that the vending machine comprises an analyzer and transfer means which upon removal of a product from said product storing means by a consumer analyses the real parameter assigned to the consumer and the image parameter allocated to the real parameter by the parameter allocation means and which exports the real parameter and the image parameter for transfer to an external device for example via internet.

Following there is a detailed description of a preferred embodiment of an advertising medium system and a vending machine provided with an advertising medium system.

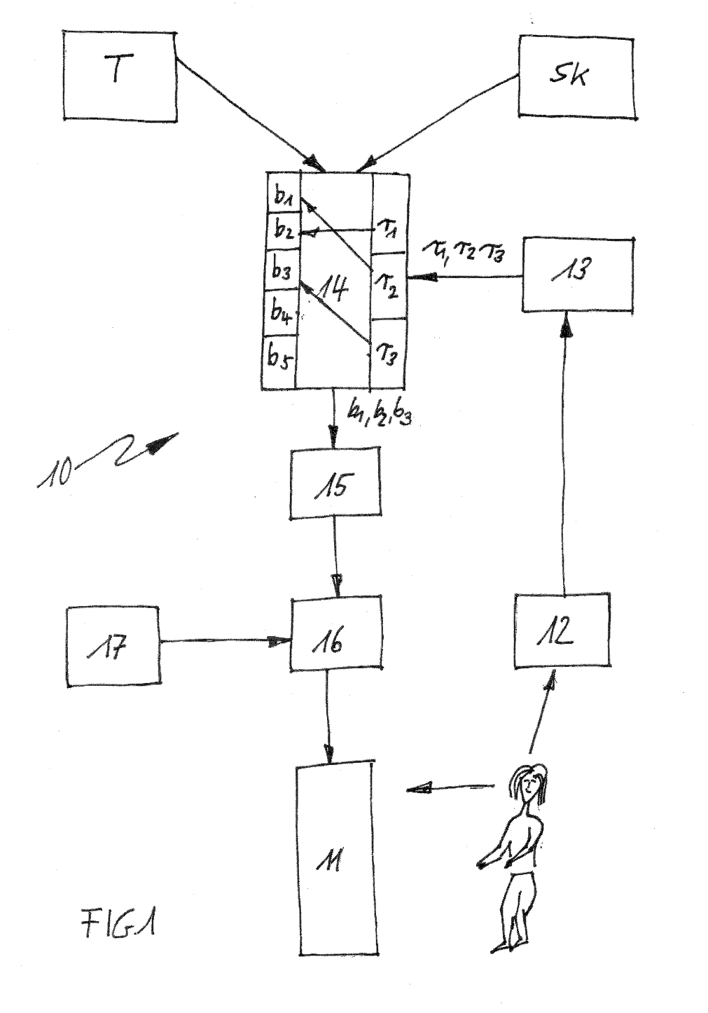

FIG. 1: a functional illustration of an advertising medium system;

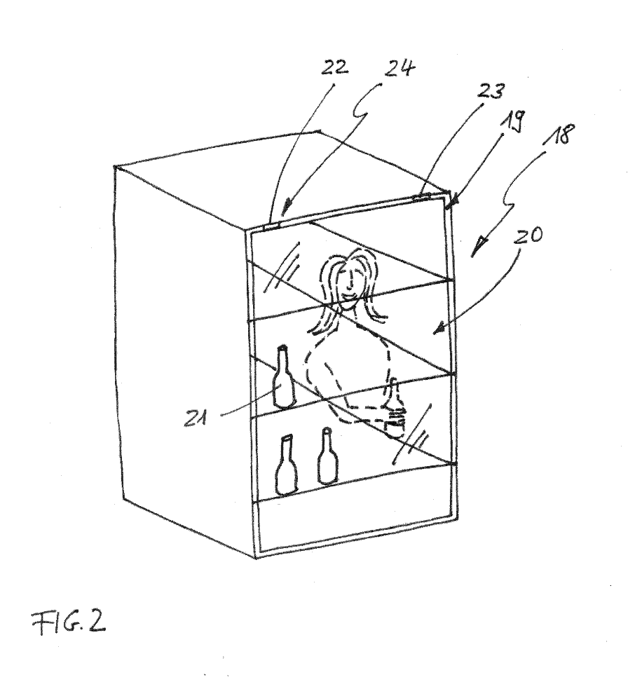

FIG. 2: a vending machine provided with an advertising medium system.

FIG. 1 shows an advertising medium system 10 and a target person staying in an advertising medium environment and having visual contact with a display means 11 being used as advertising medium for displaying advertising contents. The advertising medium system 10 as depicted comprises an image capture means 12, an image processing means 13, a parameter allocation means 14, an image generation means 15 and a display control means 16 for controlling the display means 11.

The image processing means 13 filters the image files stemming from the image capture means 12 for real parameters r defined by the filter settings, which real parameters r reflect characteristic features of the target person, as for example the sex r1, the age r2 and the hair length r3 of the target person, in order to use those real parameters r as input parameters for the parameter allocation means 14.

The parameter allocation means 14 accesses to data bases storing for example data rendering for social categorizing (SK) or standardization of type (T) of the target person, so that the parameter allocation means 14 provides for an allocation of the real parameters r1, r2, r3 to the image parameters b1, b2, b3 dependent of the data received from the data bases, which image parameters b1, b2, b3 are stored in the parameter allocation means 14 or in a data base connected to the parameter allocation means 14.

For example based on the data stemming from the data bases there could be an allocation of the combination of real parameters r1, r2, r3 to the combination of image parameters b1, b2, b3, wherein b1 means male, b2 means soccer player and b3 means long-haired, so that the image parameters b1, b2, b3 being the input parameters for the image generation means 15 effect the generation of an image sequence in the image generation means 15 showing a male long-haired soccer player. In a display control means 16 that image sequence could be superposed with a further image sequence or an image background stemming from an external image memory 17, supplementing for example a product environment matching with the product, as for example in a way that the display means 11 displays a long-haired soccer player within an orange plantation and consuming orange juice.

FIG. 2 shows a vending machine 18 embodied as a beverage refrigerator, which vending machine 18 comprising an advertising medium system 19 formed as a door and being provided with a display means 20. For covering the products stored in the vending machine 18 and being embodied as bottles 21 containing beverages the advertising medium system 19 has a transparent display enabling a diffuse identification of the bottles 21. Thus it is possible to overlay the real products stored in the vending machine 18 with the advertising contents displayed on the display means 20 which advertising contents for example being a person consuming such a bottled beverage.

In case of the shown embodiment additionally to two image capture units 22, 23 of a image capture means 24 there are also further components already referred to with regard to FIG. 1 which components being integral parts of the vending machine 18.

1. A method for adaptation of the advertising content of an advertising medium to an advertising medium environment,
which advertising medium being formed as a display means (11, 20),
wherein an image capture means (12, 24) registers a target person or a target group present in the advertising medium environment and in line of sight with the display means,
an image processing means (13) analyses the registered image information as to at least one real parameter (r1, r2, r3) characterizing the target person or the target group or the advertising medium environment,
a parameter allocation means (14) allocates at least one image parameter (b1, b2, b3) to the real parameter, which image parameter defines an image or an image sequence,
an image generation means (15) generates an image or an image sequence depending on the image parameter, and
a display control means (16) displays the image or the image sequence on the display means as advertising content.

2. Method according to claim 1,
wherein at least one feature characterizing the outer appearance of the target person is registered as said real parameter.

3. Method according to claim 1,
wherein the position of the target person or the target group relative to another person or an object within the advertising medium environment is registered as said real parameter.

4. Method according to claim 1, wherein the movement of the target person or the target group relative to another person or an object within the advertising medium environment is registered as said real parameter.

5. An advertising medium system (10, 19) for performing the method according to claim 1 comprising
a display means as advertising medium for presentation of an advertising content using an image or an image sequence, which advertising medium system further comprising an image capture means (12) for registering a target person or a target group present in an advertising medium environment and in line of sight with said display means,
an image processing means (13) for analysing the registered image information as to at least one real parameter (r1, r2, r3) characterizing the target person or the target group or the advertising medium environment,
a parameter allocation means (14) for allocating at least one image parameter (b1, b2, b3) to the real parameter, which image parameter defines an image or an image sequence,
an image generation means (15) for generating an image or an image sequence depending on the image parameter, and
a display control means (16) for displaying the image or the image sequence on the display means as advertising content.

6. The advertising medium system according to claim 5,
wherein said image processing means (13) is designed to register at least one feature characterizing the outer appearance of the target person or the target group as said real parameter.

7. The advertising medium system according to claim 5,
wherein said image processing means (13) is designed to register the position of the target person or the target group relative to another person or an object within the advertising medium environment as said real parameter.

8. The advertising medium system according to claim 5,
wherein said image processing means (13) is designed to register the movement of the target person or the target group relative to another person or an object within the advertising medium environment as said real parameter (r1, r2, r3).

9. The advertising medium system according to claim 5,
wherein said image generation means (15) comprising an image memory storing images or image sequences and comprising a processor unit for assigning said image parameter (b1, b2, b3) to an image or an image sequence and for transferring said image or said image sequence to said display control means (16).

10. The advertising medium system according to claim 5,
wherein said image capture means (24) comprising at least one first and on second image capture unit (22, 23), said first capture unit (22) being designed to register the target person or the target group and said second image capture unit (23) being designed to register the advertising medium environment.

11. The advertising medium system according to claim 5,
wherein said advertising medium system is provided with at least one sensor device for triggering the advertising medium system.

12. The advertising medium system according to claim 5,
wherein said advertising medium system is provided with at least one sensor device for registering at least one further real parameter.

13. Vending machine (18) comprising a product storing means for storing the products offered for sale wherein said product storing means being provided with an advertising medium system according to claim 5.

14. Vending machine (18) according to claim 13,
wherein said advertising medium system (19) covers optically at least partly the products stored in the product storing means with an advertising content presented with the advertising medium system (19).

15. Vending machine (18) according to claim 14,
wherein for optically covering the products said advertising medium system (19) comprises a display means being at least partly transparent.

16. Vending machine (18) according to claim 13,
wherein at least the image capture means (24) being an integral part of said vending machine.

17. Vending machine (18) according to claim 16,
wherein the advertising medium system in total being an integral part of the vending machine.

18. Vending machine (18) according to claim 13,
comprising an analyzer and transfer means which upon removal of a product from said product storing means by a consumer analyses the real parameter assigned to the consumer and the image parameter allocated to the real parameter by the parameter allocation means and which exports the real parameter and the image parameter for transfer to an external device.
